(19) United States
(12) Patent Application Publication
(10) Pub. No.: US 2016/0264389 A1
(43) Pub. Date: Sep. 15, 2016

(54) Container Top Gripping and Prying Tool

(71) Applicant: Dawn Guterman, Omaha, AR (US)

(72) Inventor: Dawn Guterman, Omaha, AR (US)

(21) Appl. No.: 14/657,068

(22) Filed: Mar. 13, 2015

(51) Int. Cl. B67B 7/44; B67B 7/16; B67B 7/40; B67B 7/15

(52) U.S. Cl. CPC B67B 7/44; B67B 7/15; B67B 7/16; B67B 7/40

(57) ABSTRACT

A hand tool is provided for removing twist-off, pry-off, and tabbed container tops. The tool comprises a first and second arm member in hinged connection to one another about a hinge pin. Each of the arm members includes a rounded portion and a handle portion, whereby the upper ends of the rounded portions are connected together at the hinge pin. The rounded portions form a rounded opening adapted to receive a bottle cap therein, whereby the handle portions are gripped together to compress the rounded portions against the cap. Along one or more of the handle portions is a bottle cap pry bar member, and along the distal end of one of the handles is a tab blade pry tool. Within the interior of the rounded portions may further be blade members to grip the outer surfaces of the bottle cap placed therein or to function as a pry tool.

### BACKGROUND OF THE INVENTION

### Field of the Invention

The present invention relates to container opening tools and bottle openers. More specifically, the present invention pertains to a handled tool utilized for gripping twist-off caps, removing pry-off caps, or and lifting tab container openings.

Removing twist-off bottle caps by hand can be difficult at times. Temperature fluctuations while in transit and other factors affect the tolerance between the bottle cap and the bottle opening, which can effectively seize the cap to the bottle and prevent ready twist-off removal. While some users may be able to break the connection and open the bottle with brut strength, many may not be able to without resorting to alternative methods. The present invention relates to a new and improved container top opening tool that provides improved grip strength for removing twist-off container tops.

Along with providing a gripping tool for twist-off caps, the present invention furthermore provides features that facilitate removal of pry-off caps and lifting of tabbed openings. Along the handle portion of the tool is a pry bar member for lifting and opening pry-off caps, whereby the cap is lifted along its periphery and bent upwards using the pry bar member. Similarly along the handle and at a distal end thereof is a blade member for lifting tab container openings.

Tab container openings are commonly utilized in the soda can arts, in which a stay-on tab is used to rupture a seal and open the can. The tab is levered towards the can lid by the user pulling upwards on the rear of the tab. The tab presses onto a scored area of the container lid and breaks the container seal. While operating this mechanism does not require undue strength, prying the tab from the upper surface of the container lid is sometimes difficult. Stay-on tabs are generally fastened to the lid and are parallel thereto prior to use. Therefore the user must pry the rear end of the tab upwards to effectuate the opening mechanism of the tab.

The present invention therefore provides a combination tool that can be used to open container caps of different style and design. The tool comprises a handled device that is first used to grip the outer surfaces of a bottle cap for twisting the same. The tool includes a planar blade portion for prying the tab of a tab container opening when opening soda cans and the like. Finally, the pry bar allows the handle of the tool to open pry-off container caps.

Use of the tool provides the user with a mechanical advantage when opening a container. The grip strength required by the user is reduced, while pry bar and tab blade members are used for removing specific cap designs that do not twist off. The tool is useful in a residential and a commercial environment, whereby users at home and those in a workplace may be assisted when opening beverage cans or equivalent containers with a diverse set of cap designs.

### SUMMARY OF THE INVENTION

The following summary is intended solely for the benefit of the reader and is not intended to be limiting in any way. The present invention provides a new combination hand tool for removing twist-off, pry-off, and tab opening container tops. The tool comprises a handled tool with a rounded portion configured to receive a bottle cap therein, while the handles include a bottle cap pry bar tool and a tab opening pry blade member.

It is therefore an object of the present invention to provide a new and improved container top combination tool that has all of the advantages of the prior art and none of the disadvantages.

It is another object of the present invention to provide a container top combination tool that can be used to remove different container caps without switching tools.

Another object of the present invention is to provide a container top combination tool that is suited for removing diverse cap types, including twist-off caps, pry-off caps, and tabbed container openings.

Yet another object of the present invention is to provide a container top combination tool that comprises a first and second arm member in hinged relationship, whereby the arms can pivot relative to one another about a hinge pin to expand around a cap and compress thereagainst.

Another object of the present invention is to provide a container top combination tool that includes arm members providing a rounded interior for grasping and twisting a twist-off container top.

Another object of the present invention is to provide a container top combination tool that includes arm members providing a rounded interior with blade members extending inward therefrom for prying a pry-off container top from a container.

Another object of the present invention is to provide a container top combination tool that includes arm members having a handle portion that includes a pry bar member therealong for prying a pry-off container top from a container.

Another object of the present invention is to provide a container top combination tool that includes arm members having a handle portion that includes tab blade pry tool for lifting and prying upwards the tab of a tab opening container.

Another object of the present invention is to provide a container top combination tool that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a frontal view of the combination tool of the present invention.

FIG. 2 shows a rear view of the combination tool of the present invention.

FIG. 3 shows an exploded view of the tool.

FIG. 4 shows a perspective view of the tool.

### DETAILED DESCRIPTION OF THE INVENTION

Reference is made herein to the attached drawings. Like reference numerals are used throughout the drawings to depict like or similar elements of the container top combination tool of the present invention. For the purposes of presenting a brief and clear description of the present invention, the preferred embodiment will be discussed as used for opening the top of a twist-off, pry-off, or tab opening container top. The figures are intended for representative purposes only and should not be considered to be limiting in any respect. The figures present an embodiment of the invention and are not to be construed as limiting the claimed invention to the depicted embodiment.

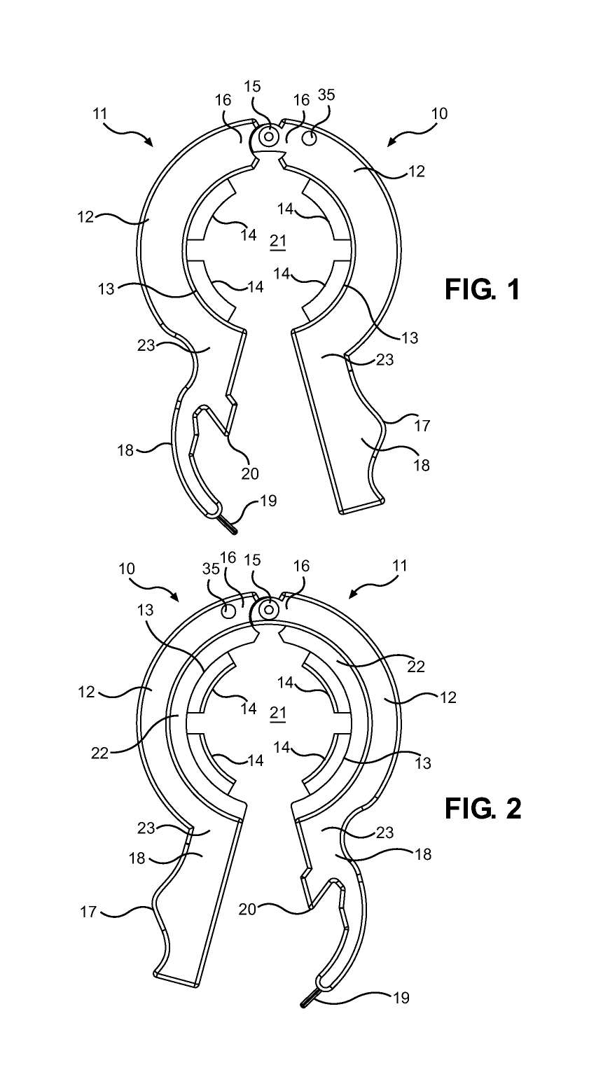

Referring now to FIGS. 1 and 2, there are show views of the combination tool from the frontal and rear perspective. The tool comprises a hand tool that can be used is several different ways to remove container tops of various style. The container tops most suited for removal by the present tool include twist off caps, pry-off caps, and tabbed opening container tops. The tool offers several elements that can be interchangeably used without switching tools, whereby a significant mechanical advantage is gained when using the tool for opening any one of the contemplated container tops.

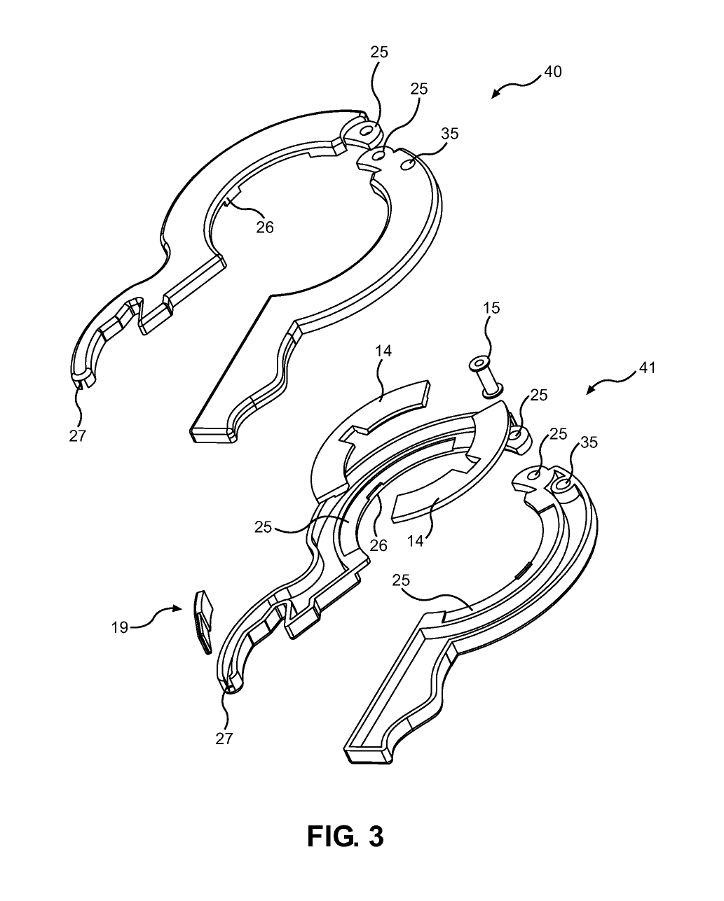

The tool comprises a first arm member 10 and a second arm member 11 pivotably connected together about a hinge pin 15. Each arm member includes an upper end 16 and a lower end 23, whereby the upper ends 16 comprise complimentary clevis arms (see FIG. 3) that overlap one another and form an opening adapted to receive the hinge pin 15 therethrough. The hinge pin 15 is secured through the clevis and pivotably secures the arm members 10, 11 together at their upper ends 16. Each of the arm members 10, 11 includes a rounded portion 12 with an upper end 16 and a lower end 23. The upper end 16 terminates at the hinge pin location. The lower end 23 of each arm member transitions or affixes to an elongated handle portion 18 extending therefrom.

The handle portions 18 are members that extend outward from the rounded portions 12 and serve as handle grip locations for the user. The arm members 10, 11, including the handle portions 18 and the rounded portions 12, are preferably members that lie in substantially the same plane. The hinge pint 15 allows the arm members 10, 11 to separate from one another in-plane, whereby the user can separate the handle portions 18 to expand or reduce the rounded interior opening 21 between the rounded members 12.

The rounded interior opening 21 between the rounded members 12 is adapted to receive a container top therein. The handle portions 18 are used to compress the rounded portions 12 against the outer surfaces of the container top placed within the interior 21 of the tool, whereafter the user apply the grip provided by the tool to grasp and twist the container top from the container. The handle portions 18 are drawn together by the user and rotated together to twist off a container top within the interior 21 of the tool.

The container top is compressed within the interior 21 of the rounded portions 12, whereby the tool frictionally removes twist-off tops. Either the interior surface 13 of the rounded portions grips the container top, or alternatively inwardly projecting blade portions 14 grip the exterior of the container top. The inwardly projecting blade portions 14 are therefore useful for gripping the outer surfaces of a container cap when removing a twist-off cap. Alternatively, the blade portions 14 are useful as a pry tool when used against a pry-off container top. Opposing blades 14 within the rounded interior 21 of the tool can be used as a prying assembly, whereby one blade 14 is placed against the upper surface of a container cap and an opposing blade 14 is placed under the outer perimeter lip thereof. The blade along the container top perimeter is lifted upwards as the blade along the upper surface acts as a pivot point, deforming the pry-off cap, breaking the container seal, and separating the container cap from the container. This operation is best conducted while holding the tool from the rounded portions 12, whereby the rounded portions 12 are placed on the pry-off cap at an angle and lifted upwards from the outer edge of the container cap in a prying motion.

The handle portions 18 are elongated members that are employed as grips by the user. One of the handle portions 18 is pressed within the user's palm, while the opposite handle portion is drawn towards the first by the user's fingers, whereby reducing the interior 21 of the tool to compress a container top. The outer handle portion may include an ergonomic outer surface 17 that conforms to the user's fingers, while the inner handle may be rounded to bear against the user's palm.

At least one of the handle portions 18 may also comprise one or more secondary container top removal elements. As shown in FIGS. 1 and 2, one of the handle portions 18 includes a pry bar member 20 and an elongated pry blade member 19. The pry bar member 20 comprises a cavity within the handle portion and an overhanging pry bar tip, which acts as a pry bar to lift the perimeter edge of a pry-off container top. In use, the handle portion 18 is gripped individually and the pry bar member 20 is placed against the outer perimeter of the container top to lift the perimeter edge thereof.

The pry blade member 19 comprises an elongated blade member having a substantially planar shape. The blade member 19 is used to lift and pry upwards the tab of a tab opening container top. This is useful for opening beverage cans, whereby the outer end of the pull tab must be lifted and separated from the upper surface of the container to break the seal and open the container. The pry blade member 19 is inserted between the tab and the upper surface of the container, whereafter the user lifts the blade member 19 to pivot the tab against the container upper surface.

The tool of the present invention is designed to be held and used in one hand and easily carried. The tool can be supported within the user's pocket, or alternatively supported by a keychain. A tether aperture 35 is therefore provided along one of the arm members, whereby a tether can be used to support the suspended tool until its use is necessary.

Referring now to FIG. 3, there is shown an exploded view of the combination tool of the present invention. This represents an exemplary embodiment of the present invention, and is not to be construed as limiting the claimed invention to the depicted construction. In this embodiment, the arm members are formed of two separate halves, whereby an upper half 40 and a lower half 41 of each arm member are joined together to form the tool. The pry blade member 19 is received within the distal end of one of the handle portions, and the inwardly projecting blade portions 14 are received within the interior of the rounded portions. The pry blade member 19 extends through a slot 27 along the distal end of the handle portion, while the inwardly projecting blade portions are secured by tab 26 that secures the blade in place. The blade portions 14 are seated within channels 25 and are sandwiched by the upper 40 and lower 41 halves of the arm members. Also visualized in FIG. 3 are the clevis members 25, which are overlapping members forming a singular through hole. The hinge pin 15 is seated within the through hole and allows the arm members to pivot relative to the hinge pin 15 by way of the clevis member attachment thereto. Finally, the tether aperture 35 is visualized through the halves of the arm portions.

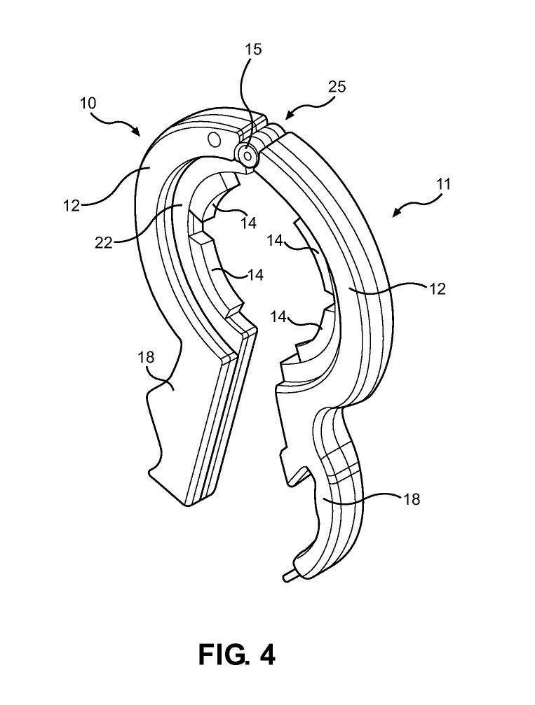

Referring finally to FIG. 4, there is shown a perspective view of the present invention. Along the rear side of the rounded portions 12 is a recessed surface 22. The recessed surface 22 extends inwardly relative to the rounded portions and supports the blade members 14. The function of the recessed surface 22 is to a cavity within which a container cap is received, whereafter the rounded portions are compressed against the sides of the cap for gripping the same. The user can therefore utilize the interior surface of the rounded portions 12 as the gripping surface, while the recessed surface rests upon the upper surface of the cap. Alternatively, the blade portions 14 may be used as the gripping surfaces of the tool. The user grips the handle portions 18 are draws them together to secure the container top within the rounded portions. Thereafter, the user can rotate the handle portions 18 to release a twist off container cap. The first 10 and second 11 arm members are pivotably from the hinge pin 15, which is held captive by the clevis members 25 along the upper end of the arm members.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A hand tool for opening containers, comprising:
a first arm member and a second arm member;
the first arm member having a rounded portion and a handle portion;
the second arm member having a rounded portion and a handle portion;
each of the rounded portions having an upper end and a lower end;
a hinge pin connecting the upper ends of the rounded portions together such that the first arm member and the second arm member are hingedly connected to each other;
the rounded portions of the first arm member and the second arm member forming a substantially rounded interior therebetween that is adapted to receive a bottle cap therein;
the handle portion of the first arm member extending outward from the lower end of the rounded portion of the first arm member;
the handle portion of the second arm member extending outward from the lower end of the rounded portion of the second arm member;
the first arm member and the second arm member being substantially disposed in the same plane;
whereby the handle portions of the first arm member and the second arm member can be pressed together to reduce the rounded interior, or separated to expand the rounded interior;
the handle portion of the second arm member further comprising a pry bar member.

2) The hand tool of claim 1, wherein the handle portion of the second arm member further comprises a pry blade member extending therefrom.

3) The hand tool of claim 1, further comprising:
a first blade member extending inwardly from the rounded portion of the first arm member;
a second blade member extending inwardly from the rounded portion of the second arm member.

4) The hand tool of claim 1, wherein the rounded portions of the first arm member and the second arm member further comprise a recessed surface along an interior perimeter thereof.

5) The hand tool of claim 1, wherein:
the hinge pin connects to the first arm member and the second arm member via clevis members forming a through hole that receives the hinge pin therethrough.

6) A hand tool for opening containers, comprising:
a first arm member and a second arm member;
the first arm member having a rounded portion and a handle portion;
the second arm member having a rounded portion and a handle portion;
each of the rounded portions having an upper end and a lower end;
a hinge pin connecting the upper ends of the rounded portions together such that the first arm member and the second arm member are hingedly connected to each other;
the rounded portions of the first arm member and the second arm member forming a substantially rounded interior therebetween that is adapted to receive a bottle cap therein;
the handle portion of the first arm member extending outward from the lower end of the rounded portion of the first arm member;
the handle portion of the second arm member extending outward from the lower end of the rounded portion of the second arm member;
the first arm member and the second arm member being substantially disposed in the same plane;
whereby the handle portions of the first arm member and the second arm member can be pressed together to reduce the rounded interior, or separated to expand the rounded interior;
the handle portion of the second arm member further comprising a pry blade member extending therefrom.

7) The hand tool of claim 6, wherein the handle portion of the second arm member further comprises a pry bar member.

8) The hand tool of claim 6, further comprising:
a first blade member extending inwardly from the rounded portion of the first arm member;
a second blade member extending inwardly from the rounded portion of the second arm member.

9) The hand tool of claim 6, wherein the rounded portions of the first arm member and the second arm member further comprise a recessed surface along an interior perimeter thereof.

10) The hand tool of claim 6, wherein:
the hinge pin connects to the first arm member and the second arm member via clevis members forming a through hole that receives the hinge pin therethrough.

11) A hand tool for opening containers, comprising:
a first arm member and a second arm member;
the first arm member having a rounded portion and a handle portion;
the second arm member having a rounded portion and a handle portion;
each of the rounded portions having an upper end and a lower end;
a hinge pin connecting the upper ends of the rounded portions together such that the first arm member and the second arm member are hingedly connected to each other;
the rounded portions of the first arm member and the second arm member forming a substantially rounded interior therebetween that is adapted to receive a bottle cap therein;
the handle portion of the first arm member extending outward from the lower end of the rounded portion of the first arm member;
the handle portion of the second arm member extending outward from the lower end of the rounded portion of the second arm member;
the first arm member and the second arm member being substantially disposed in the same plane;
whereby the handle portions of the first arm member and the second arm member can be pressed together to reduce the rounded interior, or separated to expand the rounded interior;
a first blade member extending inwardly from the rounded portion of the first arm member;
a second blade member extending inwardly from the rounded portion of the second arm member.

12) The hand tool of claim 11, wherein the handle portion of the second arm member further comprising a pry blade member extending therefrom.

13) The hand tool of claim 11, wherein the handle portion of the second arm member further comprises a pry bar member.

14) The hand tool of claim 6, wherein the rounded portions of the first arm member and the second arm member further comprise a recessed surface along an interior perimeter thereof.

15) The hand tool of claim 11, wherein:
the hinge pin connects to the first arm member and the second arm member via clevis members forming a through hole that receives the hinge pin therethrough.
